(19) United States
(12) Patent Application Publication
(10) Pub. No.: US 2002/0049575 A1
(43) Pub. Date: Apr. 25, 2002

(54) Well planning and design

(76) Inventors: Younes Jalali, Sugar Land, TX (US); Allyson Gajraj, Katy, TX (US); Soraya S. Betancourt, Ridgefield, CT (US); David L. Malone, Sugar Land, TX (US)

Correspondence Address: Schlumberger Technology Corporation, 14910 Airline Road, P.O. Box 1590, Rosharon, TX, 77583-1590, US

(21) Appl. No.: 09/952,178

(22) Filed: Sep. 12, 2001

Related U.S. Application Data
(60) Provisional application No. 60/236,125, filed on Sep. 28, 2000.
(60) Provisional application No. 60/236,905, filed on Sep. 28, 2000.
(60) Provisional application No. 60/237,083, filed on Sep. 28, 2000.
(60) Provisional application No. 60/237,084, filed on Sep. 28, 2000.

(51) Int. Cl. G06G 7/48; G06G 7/50

(52) U.S. Cl. 703/10; 703/9

(57) ABSTRACT

A method and apparatus for performing well planning and design includes several phases, including a screening phase, a design phase, and an operating phase. The screening phase selects or categorizes candidate wells in addition to performing a general-level design. The general-level design process provides a framework in which a detailed or specific design can be performed. Once a completion system for a selected well has been designed, the operating phase is performed in which measurements taken during operation are fed back to a controller. The controller has access to a conceptual model of the completion system. The measured data is compared to an expected performance based on the model. If adjustments of settings are needed, then the controller issues commands to cause various components of the completion system to be adjusted. If adjustment of settings is not sufficient to achieve the desired level of performance as indicated by the model, then an adjustment of the model may be performed.

### CROSS-REFERENCE TO RELATED APPLICATIONS

This claims the benefit under 35 U.S.C. §119(e) of U.S. Provisional Applications having Serial Nos. 60/236,125, filed Sep. 28, 2000; 60/236,905, filed Sep. 28, 2000; 60/237,083, filed Sep. 28, 2000; and 60/237,084, filed Sep. 28, 2000.

### TECHNICAL FIELD

The present invention generally relates to well planning and design.

### BACKGROUND

There are many different types of wells, which may require different completion designs for efficient operation, improved production, and extended life. More recently, with the advent of intelligent completion systems, information pertaining to the operation of the well can be retrieved and analyzed to determine if the well is producing and/or operating properly. An intelligent completion system typically includes control devices comprising of various types of downhole equipment, such as valves, that can be used for actuating the flow from one or more formation. In addition, an intelligent completion system may also include a number of sensors, gauges, or other monitoring devices to detect various well conditions (e.g., temperature, pressure, formation characteristics, etc.) and also packers for use in isolating different segments of the well completion. Placement of monitoring devices and remotely controllable devices may also affect operation of the wellbore.

Other considerations to take into account in the design of a well include the use of pumps, sand control equipment, water control equipment, the use of artificial lift systems in low-pressure wells, the number of zones to produce from, the types of hydrocarbons that will be produced, and other considerations.

With the wide variety of available completion equipment and with the large variety of different types of wells (e.g., vertical wells, deviated wells, horizontal wells, multilateral wells, etc.), it is often difficult to accurately determine the type of completion equipment that can be optimally used in a given well.

As a result, after a well has been selected and completion equipment has been installed in the well, a well operator may find that the selected well and/or completion equipment does not provide the desired or expected level of production at target costs. Therefore, a need continues to exist for improved methods and apparatus for providing efficient and cost-effective operation of wells and, by extension, optimal reservoir management.

### SUMMARY

In general, according to one embodiment, a method includes selecting a candidate well from plural possible wells using predetermined criteria. Design of a completion system for the candidate well is performed, and a model of the completion system is stored to compare against operation of the completion system.

Other or alternative features will become apparent from the following description, from the drawings, and from the claims.

### BRIEF DESCRIPTION OF THE DRAWINGS

FIG. 1 is a representation of example oil fields and wells drilled in corresponding fields.

FIG. 2 is a flow diagram of a well planning and design process, in accordance with an embodiment, including a screening phase, a design phase, and an operation phase.

FIG. 3 is a flow diagram of a process of identifying a candidate well in the screening phase of FIG. 2.

FIG. 4 is a flow diagram of a general-level design process that is part of the screening phase of FIG. 2.

FIG. 5 is a flow diagram of the design phase of FIG. 2.

FIG. 6 illustrates an example completion system that can be designed in the design phase of FIG. 5.

FIG. 7 is a graph of valve choke positions and valve flow areas to illustrate several possible designs of a valve in the completion system of FIG. 6.

FIG. 8 illustrates the operation phase of FIG. 2.

FIG. 9 is a block diagram of an example computer system in which a well planning and design tool according to an embodiment is executable.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

As used here, the terms “up” and “down”; “upper” and “lower”; “upwardly” and “downwardly”; “upstream” and “downstream”; and other like terms indicating relative positions above or below a given point or element are used in this description to more clearly describe some embodiments of the invention. However, when applied to equipment and methods for use in wells that are deviated or horizontal, such terms may refer to a left to right, right to left, or other relationship as appropriate.

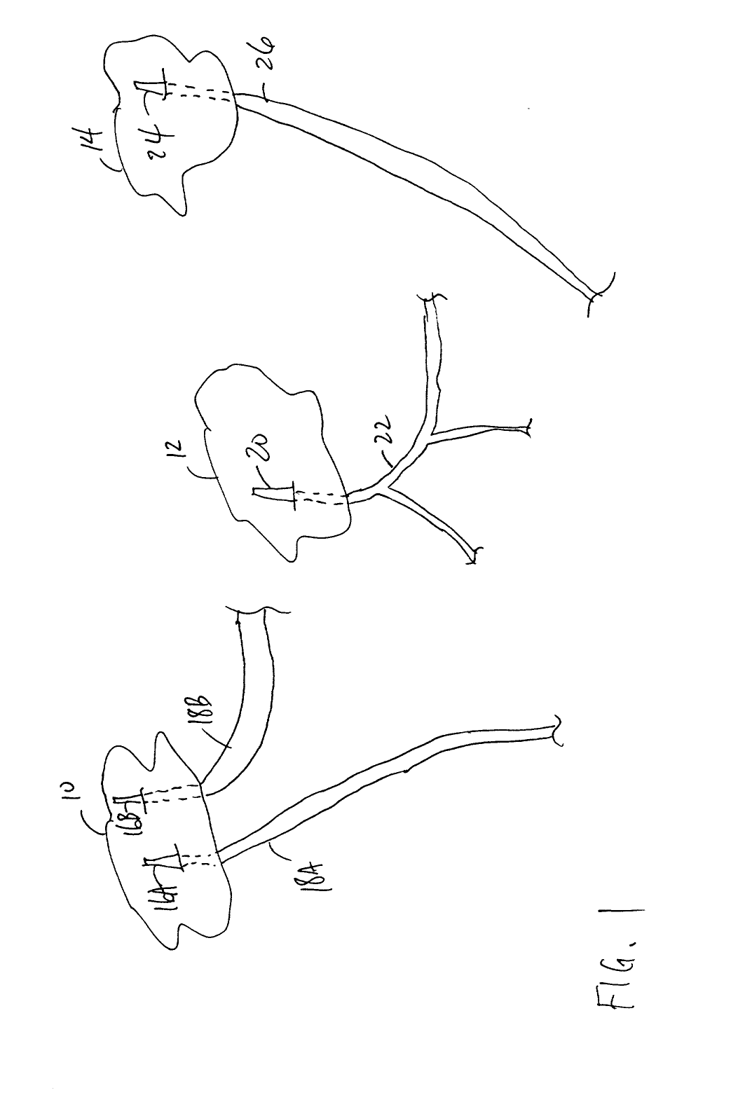

According to one example, FIG. 1 shows several oil fields 10, 12, 14, in which wells 18A, 18B, 22, and 26 have been drilled. The wells 18A, 18B, 22, 26 may be exploration wells that are used for collecting information regarding characteristics of reservoirs through which each well passes. Such information can be collected using various logging techniques. Each of the wells 18A, 18B, 22, and 26 extends from respective wellhead equipment 16A, 16B, 20, and 24.

In accordance with some embodiments, information collected about each of the wells 18A, 18B, 22, and 26 can be used by some embodiments of the invention for purposes of well planning and design. According to some embodiments, the well planning and design procedure involves three phases: screening, design, and operation.

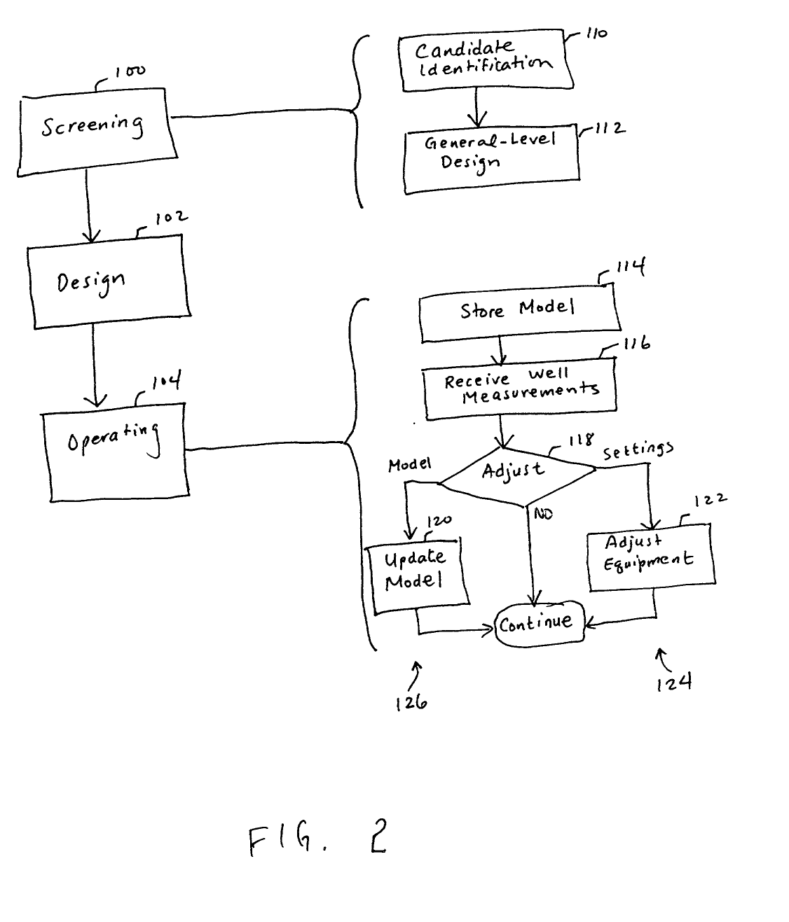

Referring to FIG. 2, a well planning and design process performs screening (at 100) of available wells to select one or more suitable candidate wells for a given type of completion technology. The screening phase (100) includes identifying (at 110) one or more candidate wells and performing (at 112) a general-level (or high-level) design. Candidate identification (110) includes choosing from multiple wells of one or more fields. Based on pre-set criteria, a candidate well is identified. Identification of candidate wells may also include categorizing different wells according to different categories of completion technology.

In one example, parameters that are used for the candidate identification include reservoir characteristics, surface facilities constraints, and economic and regulatory concerns. One reservoir characteristic is the type of drive mechanism for the reservoir. For example, the reservoir can be water-driven, gas-driven, or dual driven (driven by both water and gas). The type of drive for the reservoir determines whether an artificial lift system is needed, the type of flow control needed, and so forth. Another reservoir characteristic is the architecture of the reservoir. For example, the reservoir can be a contiguous reservoir that is made up of one contiguous zone. Alternatively, the reservoir is non-contiguous; that is, the reservoir is separated into different distinct zones that are produced into separate intervals of the wellbore. If a reservoir is non-contiguous, then, depending on the contrast in reservoir properties, compartmentalization exists so that isolation devices, such as packers, may be placed in the wellbore to isolate the different zones. Also, flow control devices may be needed in each of the zones to individually control the flow rate from each zone. The flow rates of the different zones may be set differently to provide a desired flow or pressure profile along a wellbore.

Economic factors determine the cost that is acceptable to a customer, as well as the level of production that can be achieved for a candidate well. In addition, regulatory factors determine whether the operation of a given well meets with governmental regulations (e.g., environmental regulations, etc.).

Wells selected by the candidate identification (110) can be sorted into two sub-categories: commingled and non-commingled production. Commingled production refers to production in which hydrocarbon (oil and/or gas) from different reservoirs or zones are extracted through a common conduit. Non-commingled production pertains to either single-zone wells or multi-zone wells in which different conduits are used to carry hydrocarbons from different zones. For non-commingled production, the primary application of downhole control is for water coning and/or gas cusping mitigation. For commingled production, downhole control is used for various reasons, such as optimization of production, operation flexibility, and so forth.

Once a candidate field or well has been identified, then a general-level (or high-level) design (112) is performed. The general-level design defines an overall design of the well completion system without going into specific aspects of various components of the completion system. For example, the general-level design can determine the well trajectory (e.g., deviated, horizontal, vertical, etc.) and the general reservoir-wellbore interface (e.g., sand control, fracturing, etc.). Thus, in addition to the types of completion equipment needed for efficient well production, the general-level design can also specify a drilling design (e.g., trajectory of the well). Also, the general-level design specifies the type of upper and lower completions needed. For example, the lower completion can differ based on whether the reservoir is contiguous or non-contiguous. If non-contiguous, then packers and valves are to be part of the lower completion to provide zonal isolation. Upper completion design can specify if an artificial lift system is needed, for example. Also, the general-level design can specify the types of instrumentation that may be useful for the completion. Instrumentation may include sensors or gauges to measure downhole and reservoir conditions as well as downhole control devices that are remotely activated, such as valves and the like.

In one arrangement, the general-level design (112) can be performed without performing actual simulations. For example, the general-level design can use case-based reasoning, which is based on empirical data collected from prior operations of similar wells. Alternatively, in the absence of pertinent case-based reasoning data, rule-based reasoning can be employed. In yet another arrangement, simulations can be used in performing the general-level design (112).

The detailed design phase (102) differs from the general-level design (112) performed in the screening phase (100) in that the detailed design (102) actually specifies the types of components to use in the completion system as well as individual designs of many of those components. For example, valves for a given well may have plural choke positions to provide the desired levels of incremental control. Specific choke aperture sizes can also be determined. Also, different types of artificial-lift systems can be used, including the use of pumps, gas lift systems, and so forth. Also, locations of various components in the well can be specified, such as locations of valves, pumps, and/or gas-lift valves. As another example, the length of a horizontal completion for optimal performance can be specified. The type of specific components mentioned above are provided as examples only, and are not intended to be exhaustive or to limit the scope of the invention. Optimal performance to be achieved by a design can be based on different objectives, such as maximizing NPV (net present value) or cumulative production over a specified time period.

Once the design phase (102) is completed, the well planning and design procedure moves into the operation phase (104). During the operation phase (104), a conceptual model of the well is created and stored (at 114). The conceptual model describes the entire system, including the downhole completion system as well as surface facilities, such as pipes, flow lines, and stations for flowing hydrocarbons to various destinations. Continuous adjustments of downhole components or adjustments of a model may be performed in response to monitored conditions in the wellbore.

During the operation phase (104), well measurements are received (at 116). Based on the well measurements, it is determined (at 118) whether settings of the completion system should be adjusted. If so, various downhole components are adjusted (such as settings of valves and so forth) to change the operational characteristics of the completion system. If it is determined that it is not possible to re-align the performance of the completion system to that set by the model, then it can be concluded that the current model is obsolete. There may also be other indicators that the model has become obsolete. As a result, the model is updated (at 120). The acts of the operation phase (104) are repeated during the life of the well.

Thus, as shown in FIG. 2, the operation phase (104) can be represented as having two loops: a relatively slow optimization loop 126 and a faster operation loop 124. The optimization loop 126 re-calibrates the conceptual model of the reservoir and resets operational set points or targets if necessary. The operation loop 124 is performed to check whether the system is performing within specified settings (according to the conceptual model), and if not, to adjust current settings of the completion system.

In one embodiment, the operation loop 124 can be performed at some predetermined frequency, such as daily, weekly, semi-monthly, monthly, etc. The target frequency can be adjusted by the well operator depending on whether or not more frequent or less frequent checks are necessary and whether they are cost effective. In some cases, the frequency of the optimization loop 126 may be quite high when the well is first placed into operation. However, as the model is refined with the acquisition of operational data over time, the need to perform the optimization loop 126 may be less frequent. In a multi-well system, multiple models may be kept for respective wells.

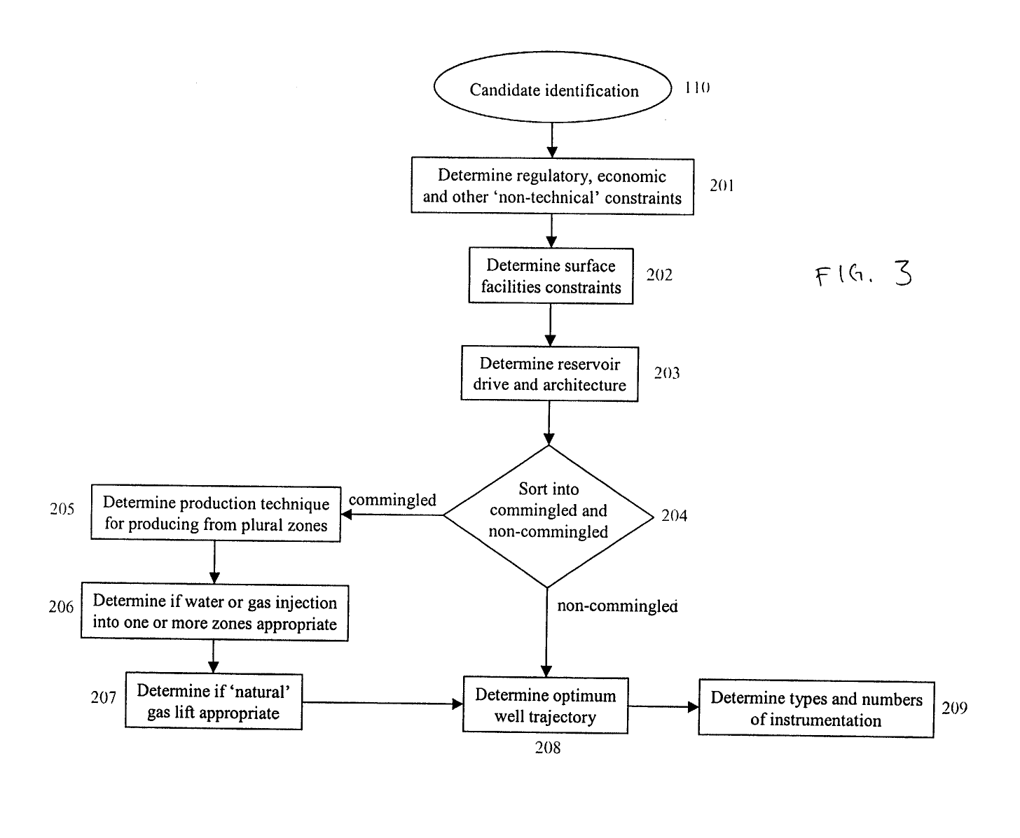

Referring to FIG. 3, the candidate identification process (110) is described in further detail. The candidate identification process determines (at 201) economic, regulatory, and other “non-technical” constraints. Examples of economic considerations include the price of oil, labor costs, equipment costs, risk considerations, and so forth. Thus, for example, if oil prices are low, then it may be determined that a particular project may not be viable. However, if oil prices are high, it may be cost effective to produce marginal wells. Regulatory constraints refer to regulations or laws imposed by governmental entities. For example, gas flaring may be prohibited in a given area, so that the added financial burden of gas handling equipment—e.g., for re-compression and re-injection of the produced gas—may make projects, in which low-pressure gas production occurs, uneconomical. Another non-technical consideration includes contractual obligations. A contract between a well operator and its customers may determine a delivery schedule that can drive how quickly and how much hydrocarbons need to be produced in a given time period.

Next, as part of the candidate identification process (110), surface facilities constraints are determined (at 202). One constraint is the required well surface pressure (the pressure at the wellhead). Additionally, limits are set on the fluid handling capacity and thus the projected rates at which a reservoir can be drained. Also, the handling capacities of surface equipment are based on the expected amount and rate of hydrocarbons from the reservoir over time. Thus, the capacity of surface facilities may place a constraint on installing completion equipment to change the production profile. For example, if the surface facilities are unable to handle additional production, then the introduction of water injection or gas lift equipment into the wellbore may not be justified.

Thirdly, the reservoir drive and well architecture are determined (at 203). The types of reservoir drive (or energy source) that may move oil toward a wellbore include: gas dissolved in oil; free gas under pressure (e.g., reservoir that contains primarily gas, or an oil reservoir with a free gas cap); fluid pressure (such as hydrostatic or hydrodynamic pressure); elastically compressed reservoir rock; gravity; or a combination of the above.

As one example of how a drive mechanism affects production strategy, a strong water drive mechanism may prompt the use of downhole valves to prevent water coning. In a reservoir that is driven by water, such as water in an aquifer below the reservoir, the pressure drawdown at the wellbore tends to pull water up into the wellbore. When an extreme drawdown exists, the resulting shape of the near-wellbore water-oil contact is shaped generally like a cone or a crest of a wave. If water coning is not controlled, then the production of water can become uncontrolled. As another example, if a combination aquifer-gas cap drive is present, then the amount of stand-off may have to be optimized between a horizontal wellbore and the gas-oil and oil-water contacts.

In one aspect, the reservoir architecture, which is another parameter considered by the candidate identification process (110), refers to the degree of compartmentalization of the reservoir. Compartmentalization may favor commingled production, where multiple zones are completed and produced simultaneously through a common wellbore.

The wells identified using the parameters determined at 201, 202, and 203 are sorted into two categories: commingled and non-commingled production. In the commingled category, a determination is made (at 205) on the production technique for producing from plural zones. For example, a formation may have multiple contrasting reservoirs with varying gas-oil ratios. The multiple reservoirs may be multiple “stacked” reservoirs, in which several reservoirs are stacked in different layers. Such a configuration (reservoir architecture) may suggest either a vertical well with completions over multiple zones or a multilateral completion for commingled production.

Also, in the commingled category, it is determined (at 206) if water or gas injection into one or more zones is appropriate. For example, injection (of water or gas) can be performed into one or more zones (via injection wells) so that the pressure created by such injection sweeps hydrocarbons in these same zones to production wells.

In a multi-zone well with commingled production, a determination is also made (at 207) to determine if natural gas lift is appropriate. Natural gas lift refers to the production of gas from the same or a different reservoir to reduce the hydrostatic gradient of the fluid in the production tubing and lift the liquid phases from of the reservoir that has inadequate pressure support.

In the non-commingled category, the optimum well trajectory and type of instrumentation are determined (at 208 and 209, respectively). Determinations of the optimum well trajectory and type of instrumentation are also made in the commingled category, after the other considerations (205, 206, 207) have been made. In a horizontal or highly-deviated wellbore, one criterion for potential instrumentation is whether the frictional pressure drop from the toe to the heel of the wellbore is greater than the pressure drawdown from the reservoir to the sandface. Problems that tend to arise under such conditions are those of water coning and/or gas cusping.

With the use of intelligent completions, active control of water coning and gas cusping can be performed. Active control has an advantage over passive control in that a well operator may both pro-actively use downhole valve settings to initiate production control in anticipation of future problems, and also to react to the development of unexpected problems during production.

Reservoir/wellbore configurations that tend to exhibit coning or cusping behavior include long horizontal completion sections. This is due to the fact that frictional pressure drop is directly proportional to the length of a wellbore. In addition, a relatively small wellbore diameter may encourage water coning or gas cusping effects, since a smaller diameter wellbore tends to induce higher frictional pressure losses. Also, relatively high near-wellbore vertical or horizontal permeability contrasts may enhance the likelihood of water coning or gas cusping. This is because pressure drawdown is inversely proportional to the permeability of the formation, so that higher permeability leads to lower drawdown, which increases the possibility that frictional pressure drop becomes dominant.

Use of instrumentation (such as valves or other control equipment and gauges or monitors) in a wellbore can delay the onset of water coning at the heel of a horizontal wellbore. Another advantage of using instrumentation is the ability to position the wellbore closer to the oil-water boundary to take advantage of the better displacement via the gas (usually there is a lower residual oil saturation in a gas-oil system compared to an oil-water system). Instrumentation can also be helpful in situations where two or more horizontal wells are completed in the same reservoir.

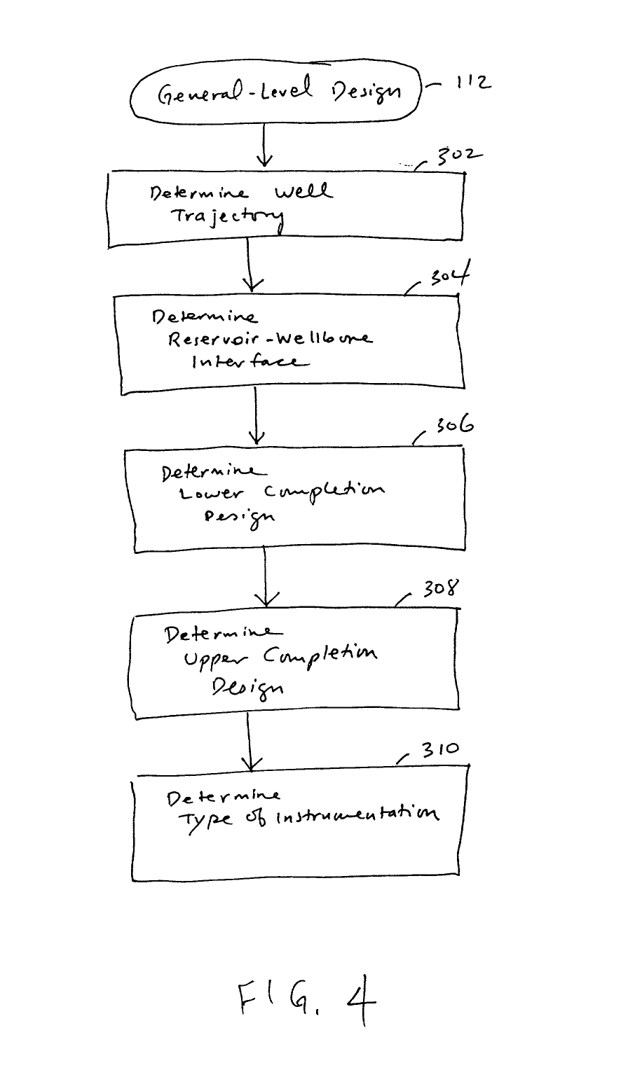

Referring to FIG. 4, the general-level design process (112) is discussed in greater detail. As part of the general-level design (112), the well trajectory for a given reservoir is determined (at 302). Possible well trajectories include horizontal, deviated, vertical, or multilateral. In certain reservoirs, a multilateral completion strategy may result in improved production when compared to multiple horizontal or vertical wells.

The type of reservoir-wellbore interface is also determined (at 304) in the general design process. Depending upon the type of formation, sand control equipment may be needed, such as sand screens, gravel packing, etc.

The general-level design also determines (at 306) the lower completion design. Design considerations for the lower completion include whether segmentation of the wellbore with packers or other sealing mechanisms is needed. Also, it is determined if valves are needed for flow control and if other instrumentation (such as gauges or sensors) is needed. A recommendation can also be made regarding whether instrumentation is needed in each of plural zones, or in some subset of the zones., If injection (of water or gas) is needed, flow control devices for injection of water or gas can be part of the lower completion design.

The general-level design also determines (at 308) the upper completion design. Upper completion design involves the determination of whether an artificial lift system is needed, such as a gas lift system or a pump system. Also, the types of instrumentation to be included in the completion system are determined at (310). For example, instrumentation may include monitoring devices with sensors to measure pressure, fluid flow rate, surface rate, formation resistivity (Resistivity Array), and distributed temperature along the well (Distributed Temperature Sensor).

As noted above, the general-level design process involves the use of case-based reasoning. In case-based reasoning, a database is maintained, which database stores designs of completion systems that have been used in the past. The information from the database can be subsequently used for other general-level designs. As an alternative to case-based reasoning, rule-based reasoning can be used. For example, if a search of the database does not find information to enable case-based reasoning, then rule-based reasoning may be used. Rule-based reasoning is a process in which the design reasoning is based on empirical rules for the selection of various design components where empiricism evolves from sound engineering practice. As a simple example, such rules may determine that sand control is required if the formation is unconsolidated. As the wealth of design examples increases and design techniques mature, a shift may occur from rule-based reasoning to case-based reasoning.

The general-level design process (112) provides a framework within which a detailed or specific design process (102) can be performed. For detailed design, a simulator tool is typically used. Some simulation tools, such as the Eclipse™ reservoir simulator (with implementation of Eclipse's Multi-Segment Wellbore Model (MSWM)) can be used. Such simulator tools provide simulation of fluid flow in various types of wells (such as vertical, deviated, horizontal, or multilateral wells). Given simulated fluid flow conditions, designs of valves or other flow control devices can be determined. A valve or flow control device design analyzes the impact of various combinations of choke settings on objectives such as maximizing NPV or hydrocarbon recovery. Actual choke aperture sizes can be determined for controlling expected influxes from the reservoir. The length of a horizontal section of the wellbore can be determined for optimum performance.

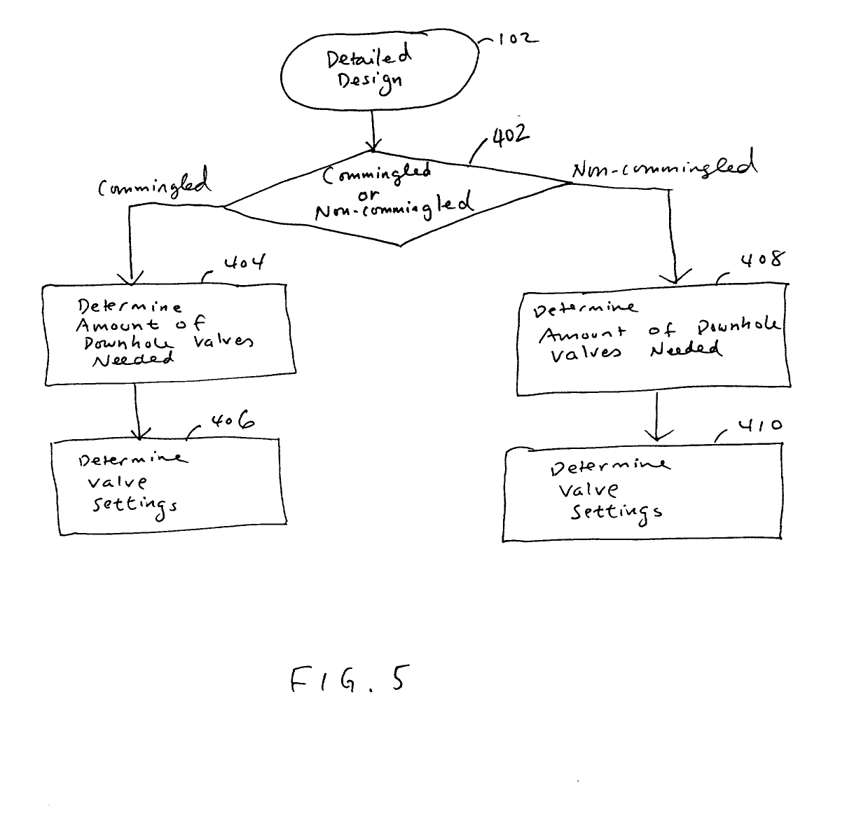

Referring to FIG. 5, in the detailed design process (102), it is first determined (at 402) if the given well has a commingled or non-commingled production scenario. If commingled, the number of downhole valves needed is determined (at 404). The need for downhole valves was determined in the general-design process (at 112). Commingled production usually implies more than one downhole valve since flow control in multiple zones may be needed. One exception may be in a situation where natural gas lift (using gas from a contiguous or non-contiguous gas reservoir) is performed, in which case only one valve may be required.

Next, valve settings are determined (at 406). Valve settings can be based on various considerations. For example, if a well has two zones, and the upper zone has an edge water drive while the lower zone has a bottom water drive, a fixed choke valve in the upper zone and an adjustable valve in the lower zone can be used. Apertures of the adjustable valve are designed to allow production control in the lower reservoir. For example, an optimum design may require a dramatic reduction in aperture from the fully opened (no control) position to the next largest position if control is to be initiated from that position. In such cases, a linear design (in which the valve flow area varies linearly with each setting) may have a limited ability to control the flow.

As another example, a well may have multiple isolated zones, with a top zone having a gas cap and a lower zone having a bottom aquifer. In such a scenario, valves may be used for controlling gas production as well as the production of water.

In the non-commingled scenario, if downhole valves are needed, the number is also determined (at 408). The position of the valves can be set to segment the wellbore into multiple sections so that the frictional pressure drops can be distributed within the wellbore such that water coning and/or gas cusping is mitigated. Also, the valves can be used so that water encroachment occurs uniformly along the length of the wellbore. Placement of valves in the non-commingled wellbore is also determined (at 410).

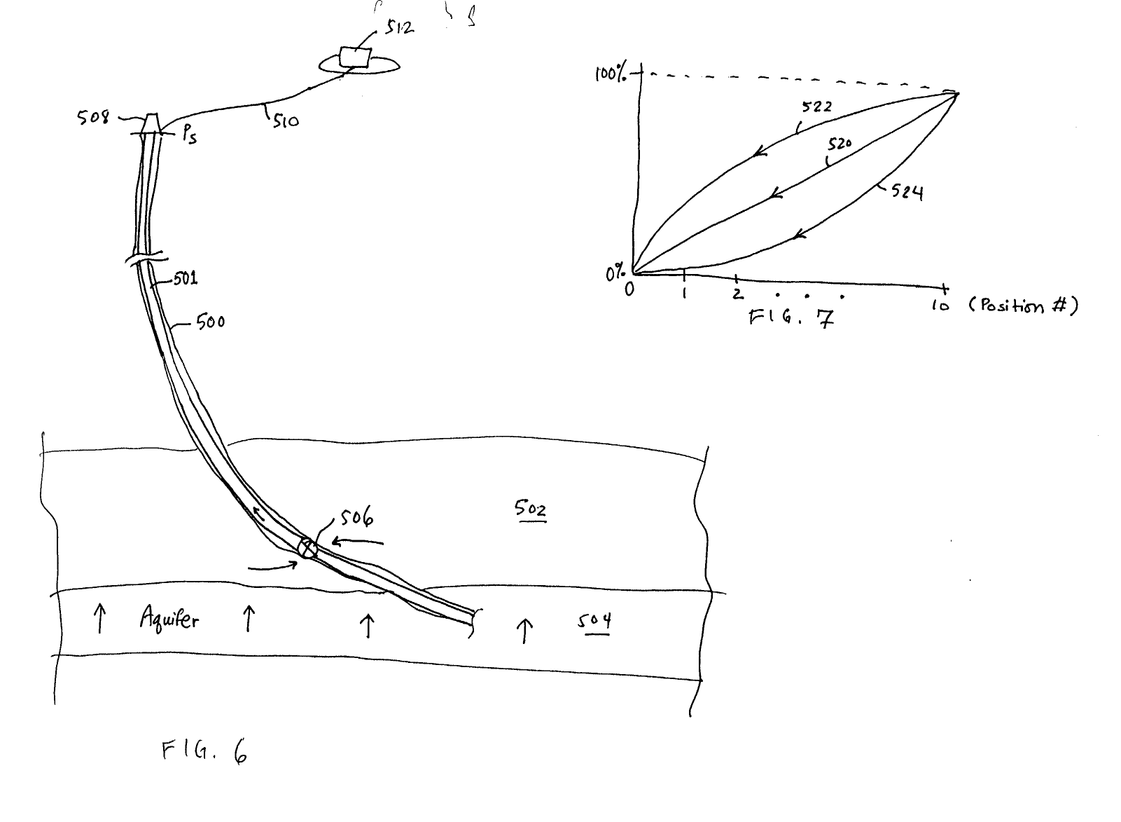

Referring to FIG. 6, an example of completion equipment for use in a non-commingled well 500 is illustrated. The detailed design phase (102) addresses characteristics of various components of the completion system. The well is associated with the surface facility that includes a flow line 510 that runs from a wellhead 508 to a surface station 512. The surface station 512 can be a sea vessel if the well is a subsea well. A tubing 501 extends from the wellhead 508 into the wellbore 500. The wellbore 500 extends through a reservoir 502. Below the reservoir is an aquifer 504. In this example, production in the reservoir 502 is driven by water in the aquifer 504. To control the inflow rate of the hydrocarbon from the reservoir 502, a valve or other type of flow control device 506 is attached to the production tubing 501. The valve 506 (e.g., a hydraulic valve) can have multiple choke settings to control the flow rate. The valve 506 can alternatively be a non-discrete valve.

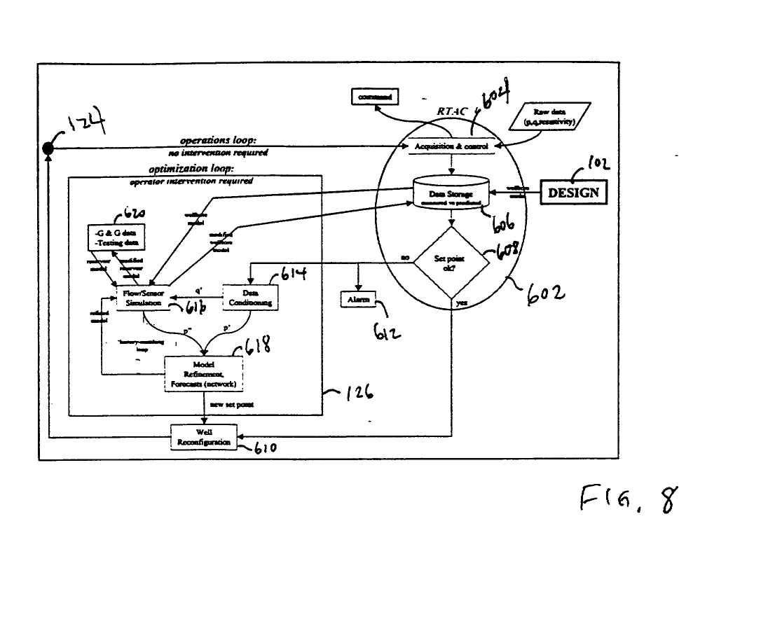

Referring to FIG. 7, the graph illustrates the percentage of flow area of the valve 506 with respect to a plurality of choke positions. In the example of FIG. 7, 10 choke positions are provided in the valve 506, with position 10 providing a 100% flow area (fully open) and position 0 providing a 0% flow area (fully closed).

Three curves 520, 522 and 524 are illustrated in the graph of FIG. 7. A first curve 520 shows a linear relationship between the choke positions of the valve 506 and the flow areas. Thus, with each change in choke position, the flow area varies linearly. It is also possible that the flow area can vary non-linearly with the choke positions, as illustrated with curves 522 and 524. Other relationships aside from the curves 520, 522, and 524 can also be specified.

Depending on the characteristics of the reservoir 502 (e.g., reservoir pressure), the valve profile can be designed to achieve a desired relationship between the different settings of the valve 506 and corresponding flow areas. For example, one of the curves 520, 522, and 524 (or some other relationship) can be selected.

As noted above, the design of valves attempts to mitigate the problems associated with water coning and gas cusping. One of the problems of water coning or gas cusping is that fluid (water or gas) entering the wellbore from the reservoir causes a reduction in the production of oil. The severity of coning/cusping can be diagnosed by comparing the drawdown at the heel portion of the well to the pressure drops occurring from the toe to the heel of the well. As the wellbore pressure drops become dominant, coning/cusping becomes pronounced. The liquid flow rate target is a parameter that has a significant impact on coning/cusping tendency. Increasing the production rate increases the reservoir drawdown and toe to heel pressure drop simultaneously. Rate change has an even more pronounced effect on frictional losses since wellbore frictional pressure drop is proportional to the square of the velocity. Since horizontal wells are not perfectly horizontal, but are undulating due to geosteering constraints during drilling, greater frictional pressure drops also result from the undulations.

Downhole flow control valves can be used to delay or prevent coning/cusping tendency or to control production after gas or water has broken through. Location of the valves is important in terms of the equilibration of the drawdown at each inflow section. By equilibrating the inflow, the coning/cusping tendency can be mitigated. Electrical valves provide for greater resolution of valve openings and closures, while hydraulic valves have a discrete number of settings from fully open to fully closed. Although electrical valves provide more flexibility than hydraulic valves, electrical valves are also generally more expensive.

The number and positioning of valves can be modeled by using numerical simulation. Thus, in one example embodiment, the well can be divided into multiple segments, so that the well is represented as a series of segments arranged in sequence along the wellbore. A multilateral well can be represented as a series of segments along its main stem, with each lateral branch including a series of segments. Each segment is represented as a node and a flow path. Each node lies at a specific depth in the wellbore, and is associated with a nodal pressure. Each segment also has a specific length, diameter, roughness, area, and volume. The volume is used for wellbore storage calculations, while the other attributes are properties of its flow path and are used in the friction and acceleration pressure loss calculations. Using such a representation of a wellbore, various combinations of valve locations and numbers of valves can be considered by performing simulations using the simulator tool.

In the multi-segment well model, each valve can be modeled as a “labyrinth” inflow control device. This type of device is used to control the inflow profile along a horizontal well or branch by imposing an additional pressure drop between the annulus and the tubing. The device is placed around a section of the tubing and diverts the fluid inflowing from the adjacent part of the formation into a series of small channels before it enters the tubing. The additional pressure drop that it imposes depends upon the length of the flow path through the system of channels, which is adjustable. A series of labyrinth devices with different channel settings can be placed along the length of a horizontal well or branch, with the aim, for example, of constraining the flow and thus reducing the variation of the drawdown along the horizontal well or branch. A detailed description of one example of a design process for wellbores is described in U.S. Provisional Application Serial No. 60/237,083, filed Sep. 28, 2000, which is hereby incorporated by reference. Another study further indicates that the use of instrumentation (e.g., valves) is effective in controlling water coning. This study is discussed in U.S. Provisional Application Serial No. 60/237,084, filed Sep. 28, 2000, which is hereby incorporated by reference.

Yet another study concluded that high friction loss wells (e.g., long horizontal wells, wells having smaller completion systems, wells with high permeability reservoirs) are suitable candidates for instrumentation to mitigate the effects of water coning and gas cusping. This study is discussed in U.S. Provisional Application Serial No. 60/236,125, filed Sep. 28, 2000, which is hereby incorporated by reference. A further study indicates that instrumentation used to mitigate effects of gas cusping can allow production to be accelerated without decreasing gas breakthrough time. This further study is discussed in U.S. Provisional Application Serial No. 60/236,905, filed Sep. 28, 2000, which is hereby incorporated by reference.

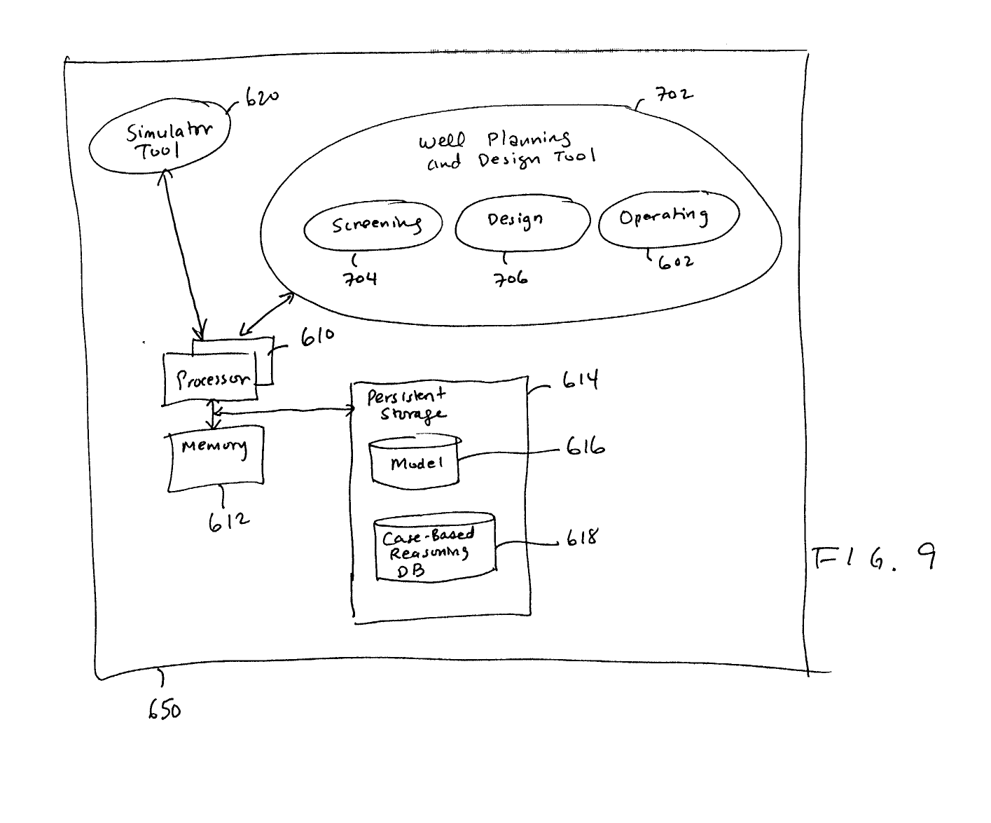

Referring to FIG. 8, the operation phase (104) of the well planning and design procedure described herein is illustrated. In one embodiment, the operation phase is controlled by a control system 602, which includes an acquisition and control module 604 and a data storage module 606. The control system 602 acquires raw data that is measured by downhole sensors, with such data including pressure, flow rate, resistivity, temperature, and so forth. Based on the acquired information, the control system determines (at 608) if a set point of the conceptual model developed during the design stage (102) can be met by the completion design. If the set point can be met, then the control system 602 sends commands (at 610) to perform reconfiguration (if necessary) of the completion system in the well to bring the operation in line with the set point provided by the conceptual model. Control then proceeds back to the initial stage of acquiring measured data from the well. This is the operation loop (124).

However, if the control system 602 determines (at 608) that the set point provided by the conceptual model cannot be met, then the control system 602 generates an alarm (at 612) and proceeds to the optimization loop (126). Data conditioning is first performed (at 614) on the measured data, which includes pressure (P) and fluid rate (Q) in one example. Data conditioning refers to filtering or other corrections of data measured by sensors to remove the effects of noise or other anomalous sensor behavior (e.g. ‘drift’). The filtered flow rate (Q′) is provided to a simulator, where simulation is performed (at 616) based on the measured flow rate. Filtered pressure data (P′) is provided to a process which performs model refinement (at 618). Using test data 620, the flow simulation (at 616) generates a simulated pressure value (P″) based on the current model. The simulated pressure value (P″) is provided to the model refinement block (618). Based on a comparison of the measured pressure P′ and simulated pressure P″, the model refinement block (618) generates a refined model that is fed to the simulation 616. This loop continues until the model has been modified to cause P′ and P″ to match. When that occurs, the refined model is fed to the control system 602 to perform reconfiguration of the well completion system.

Referring to FIG. 9, the various processes described for the screening, design, and operation phases can be performed by a well planning and design tool 702, which can be implemented as one or more software modules. The well planning and design tool 702 includes a screening module 704 (for performing the screening phase), a design module 706 (for performing the design phase), and the acquisition and control module 602 (for performing the operation phase). The well planning and design tool 702 is executable on one or more processors 710, which are coupled to a memory 712 and persistent storage 714 (e.g., magnetic storage media or optical storage media). The persistent storage 714 contains a first database 716 for storing conceptual models of different wells used during the operation phase, as well as a case-based reasoning database 718 for use during the general-level design process of the screening phase. A simulator tool 720 is also present in the system 750, with the simulator tool 720 implemented as a software module executable on the one or more processors 710. The simulator tool 720 is used during the design phase by the design module 706.

Collectively, the one or more software modules can be referred to as a “controller.” As used herein, a controller can further refer to hardware. Thus, “controller” can refer to software, hardware, or a combination of both. In addition, “controller” can refer to plural software components, plural hardware components, or a combination thereof.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of performing well planning and design, comprising:
selecting from a plurality of wells at least one of the wells, wherein selecting is based on at least one of the following factors: type of reservoir drive, reservoir architecture, constraints of surface facilities, economic constraints, regulatory constraints, and contractual constraints;
performing a design of the completion system for the well; and
performing an operation phase, wherein the operating phase comprises storing a model of the completion system, receiving measured data from the completion system, and adjusting one of a completion system setting and the model based on the received measured data.

2. The method of claim 1, further comprising performing a candidate well screening phase, wherein selecting one of the wells is performed in the candidate well screening phase.

3. The method of claim 2, wherein performing the design comprises performing a detailed design of components of the completion system, the screening phase further comprising performing a general-level design of the completion system.

4. The method of claim 3, wherein performing the general-level design comprises selecting a trajectory of the one well.

5. The method of claim 4, wherein selecting the trajectory comprises selecting one of a vertical, deviated, horizontal, and multilateral trajectory.

6. The method of claim 3, wherein performing the general-level design comprises determining a type of device to use for a reservoir-wellbore interface in the one well.

7. The method of claim 6, wherein determining the type of device to use comprises determining if sandface equipment is needed.

8. The method of claim 3, wherein performing the general-level design comprises determining an upper completion design.

9. The method of claim 8, wherein performing the general-level design further comprises determining a lower completion design.

10. The method of claim 3, wherein performing the general-level design comprises determining a type of instrumentation.

11. The method of claim 1, wherein selecting one of the wells comprises selecting a well with non-commingled production.

12. The method of claim 1, wherein selecting one of the wells comprises selecting a well with commingled production.

13. The method of claim 1, wherein performing the design comprises designing choke positions of a valve.

14. The method of claim 1, wherein performing the design comprises determining placement of valves.

15. The method of claim 1, wherein storing the model of the completion system is based on the design.

16. The method of claim 15, further comprising adjusting settings of the completion system during operation of the completion system based on the model.

17. The method of claim 16, further comprising adjusting the model if the model is not valid.

18. The method of claim 1, wherein the acts of selecting, performing the design, and performing the operating phase are performed by one or more software modules.

19. A system comprising:
at least one storage module to store information pertaining to characteristics of plural wells; and
a controller adapted to select at least one of the wells based on the stored information,
the controller adapted to further design a completion system for the at least one selected well.

20. The system of claim 19, wherein the information comprises at least one model of at least one of the wells.

21. The system of claim 19, wherein the information comprises plural models of respective plural wells.

22. The system of claim 19, wherein the controller is adapted to further perform an operation phase, the operation phase comprising storing a model of the completion system in the at least one storage module and updating settings of the completion system based on the model.

23. The system of claim 22, wherein the controller is adapted to further update the model if operation of the completion system indicates that at least one set point provided by the model is not achievable.

24. The system of claim 23, wherein the controller is adapted to further receive measured data pertaining to operation of the well.

25. An article comprising at least one storage medium containing instructions that when executed cause a system to:
select a candidate well from plural possible wells using predetermined criteria;
perform design of a completion system for the candidate well; and
store a model of the completion system to compare against operation of the completion system.

26. The article of claim 25, wherein the instructions when executed cause the system to determine if settings of the completion system need to be adjusted based on the model.

27. The article of claim 26, wherein the instructions when executed cause the system to determine if the model is obsolete.

28. The article of claim 27, wherein the instructions when executed cause the system to update the model.

29. The article of claim 25, wherein the instructions when executed cause the system to perform one of an optimization loop to update the model and an operation loop to adjust settings of the completion system.

30. A method comprising:
selecting a candidate well from plural possible wells using predetermined criteria;
performing design of a completion system for the candidate well; and
storing a model of the completion system to compare against operation of the completion system,
wherein performing design of the completion system comprises selecting settings of flow control devices to control at least one of water coning, gas cusping effects, reservoir sweep, gas production, water production, cross flow, and injection rates.
